(19) United States
(12) Patent Application Publication
(10) Pub. No.: US 2007/0151161 A1
(43) Pub. Date: Jul. 5, 2007

(54) Cursor with dampener

(75) Inventors: Everardo A. Hernandez, Shelby Township, MI (US); Santhosh Kumar Karumuri, Inkster, MI (US); Devadas Nayak Kumbla, Farmington Hills, MI (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/324,459

(22) Filed: Jan. 3, 2006

(51) Int. Cl. E05F 11/38

(52) U.S. Cl. 49/375

(57) ABSTRACT

A window regulator assembly includes a cursor that is guided by a window lift rail within a vehicle door module. The cursor includes structure for supporting a window panel, and is movable between a full up position and a full down position. The cursor includes a dampener that dampens impact as the cursor moves to the full down position by compressing a portion of the dampener against the window lift rail during impact.

### TECHNICAL FIELD

The subject invention relates to a cursor for a window regulator assembly that includes a dampener that dampens impact as the cursor moves on a rail to a full down position.

### BACKGROUND OF THE INVENTION

Window regulator assemblies include rails that are mounted to a carrier. The rails guide cursors that support a window panel for movement between open and closed positions within a vehicle door module. The cursors move relative to the rails between full up and full down positions.

As the cursor moves to the full down position, the cursor contacts a portion of a corresponding rail. This impact generates noise and can damage the cursor. One solution involves installing a downstop or bumper on the rail such that as the cursor moves to the full down position, the cursor contacts the bumper. The bumper is made from a rubber material to reduce the adverse effects of impact.

One disadvantage with this solution is that a separate piece must be installed onto the rail, which makes assembly more complex and increases cost. Another disadvantage with this solution is that this bumper has a greater tendency to fail during durability testing than other window regulator components. Damage to the bumper requires replacement, which further increases cost.

Another solution utilizes a pair of posts with an interconnecting circular bar that is formed as part of the cursor. A leg piece extends outwardly from the circular bar to contact the rail. When the leg makes contact with the rail a torsional force is generated at the circular bar. A disadvantage with this solution is that impact noise is not always effectively diminished.

Thus, there is a need for a window regulator assembly with a dampener for effectively dampening the effects of impact, but which does not require a separate bumper piece to be attached to the rail.

### SUMMARY OF THE INVENTION

A cursor for a window regulator assembly includes a cursor body that has structure to support a window panel. A dampener is attached to the cursor body to dampen impact as the cursor moves to a full down position by compressing a portion of the dampener against an associated rail.

Preferably, the dampener and the cursor body are integrally formed together as a single piece component. Thus, the dampener moves with the cursor as the cursor moves along a linear path between full up and full down positions. The dampener compresses along an axial path generally parallel to the linear path.

The window regulator assembly includes first and second rails that are mounted to a carrier positioned within a vehicle door module. At least one cursor is guided by each of the first and second rails during movement of the window panel. A drive mechanism is used to move the cursors relative to the first and second rails. When the cursor reaches the full down position, the dampener contacts a portion of the rail. When the cursor is moved from the full down position toward the full up position, the dampener is moved out of contact with this portion of the rail.

The dampener includes at least one recess that is at least partially surrounded by a wall portion. During impact, the wall portion collapses inwardly toward a center of the at least one recess to dampen impact.

The subject invention provides a cursor with a dampener that reduces the effects of impact against a respective rail as the cursor moves to the full down position without requiring a separate bumper piece to be mounted to the rail. These and other features of the present invention can be best understood from the following specification and drawings, the following of which is a brief description.

### BRIEF DESCRIPTION OF THE DRAWINGS

FIG. 1A is a schematic representation of a vehicle door module with a window regulator assembly incorporating the subject invention.

FIG. 1B is a schematic representation of a cursor and rail assembly.

FIG. 2 is one example of a cursor and dampener incorporating the subject invention.

FIG. 3 is another example of a cursor and dampener incorporating the subject invention.

FIG. 4 is another example of a cursor and dampener incorporating the subject invention.

FIG. 5 is another example of a cursor and dampener incorporating the subject invention.

FIG. 6 is another example of a cursor and dampener incorporating the subject invention.

### DETAILED DESCRIPTION OF THE PREFERRED EMBODIMENT

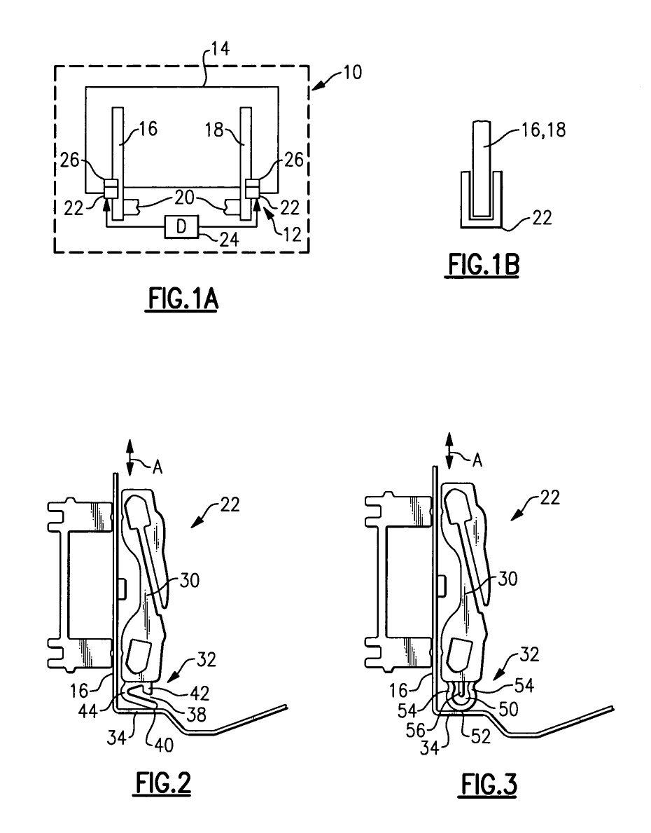

A vehicle door module 10 is shown schematically in FIG. 1A. The vehicle door module 10 includes a window regulator assembly 12 that is used to move a window panel 14 between open and closed positions. The window regulator assembly 12 includes first 16 and second rails 18 that are mounted to a carrier schematically shown at 20. The window regulator assembly 12 also includes at least one cursor 22 that is supported by each of the first 16 and second 18 rails. The cursors 22 are advantageously formed to face opposing sides of the first 16 and second 18 rails as shown in FIG. 1B. Thus, the first 16 and second 18 rails serve to guide the cursors 22 as the cursors 22 move between full up and full down positions.

A window drive mechanism, schematically shown at 24 in FIG. 1A, is used to move the cursors 22 relative to the first 16 and second 18 rails. Any type of window drive mechanism 24 can be used. The operation and structure of the various types of window drive mechanism are well known and will not be discussed in detail.

The cursors 22 include structure 26 that is capable of supporting the window panel 14. This structure 26 can comprise a clamping or fastening type structure, for example. The structure 26 allows the cursors 22 to be mounted to the window panel 14 such that the window panel 14 moves with the cursors 22 along the first 16 and second 18 rails.

One example of a cursor 22 is shown in FIG. 2. The cursor 22 includes a body 30 that is supported by the first rail 16. The body 30 includes structure that faces opposing sides of the first rail 16. The body 30 is mounted such that the cursor 22 can move relative to the first rail 16 along a generally linear path indicated by arrow A. The body 30 includes a dampener 32. The dampener 32 moves with the body 30 along a generally linear path as the cursor 22 moves along the first rail 16. Preferably, the dampener 32 is only positioned on one side of the first rail 16.

The dampener 32 is preferably integrally formed with the body 30 as one piece. This simplifies manufacturing and assembly, and accordingly reduces cost. The dampener 32 can be made from a common material with the body 30, or the dampener 32 can be made from a different material that is molded within the body 30. In one example, the dampener 32 is made from a resilient or deformable material to provide a dampening effect.

When the cursor 22 moves to the full down position, the dampener 32 contacts, abuts, or impacts a portion 34 of the first rail 16 as shown in FIG. 2. During impact, the dampener 32 compresses inwardly toward the body 30 along an axial path that is generally parallel to the linear path defined by movement of the body 30 along the first rail 16. When the cursor 22 is moved from the full down position toward the full up position, the dampener 32 is moved out of contact with this portion 34 of the first rail 16.

The dampener 32 is configured to reduce the adverse effects of impact against the first rail 16. Different examples of cursors 22 are shown in FIGS. 2-6. The body 30 of each of the cursors 22 in the examples is generally the same. Only the configuration of the dampener 32 varies between the different examples. Further, each dampener in the following examples includes at least one recess that is at least partially surrounded by a wall portion. During impact, the wall portion collapses inwardly toward a center defined by the recess to dampen impact.

The dampener 32 in FIG. 2 has a recess that is formed generally as a slot 38. A finger portion 40 comprises the portion of the dampener 32 that contacts the first rail 16 when the cursor 22 is in the full down position. Spaced from finger portion 40 is a lip portion 42 that extends downwardly toward the finger portion 40. The dampener 32 includes a connecting portion 44 that interconnects the finger portion 40 and lip portion 42. The connecting portion 44, lip portion 42, and finger portion 40 cooperate to define the slot 38. During impact, the finger portion 40 collapses or deflects inwardly toward the lip portion 42, and may even contact and compress the lip portion 42, to provide increased dampening.

The dampener 32 in FIG. 3 includes a recess that is formed as an internal cavity 50. The internal cavity 50 is completely enclosed within the dampener 32. The dampener 32 includes a body portion 52 with leg portions 54 that are spaced apart from each other to form a wall that surrounds the internal cavity 50. A protruding portion 56 is positioned within the internal cavity 50 and is spaced from the leg portions 54. During impact, the body portion 52 compresses or deflects inwardly toward a center of the internal cavity 50. Part of the body portion 52 and/or the leg portions 54 could contact and compress the protruding portion 56 to provide increased dampening.

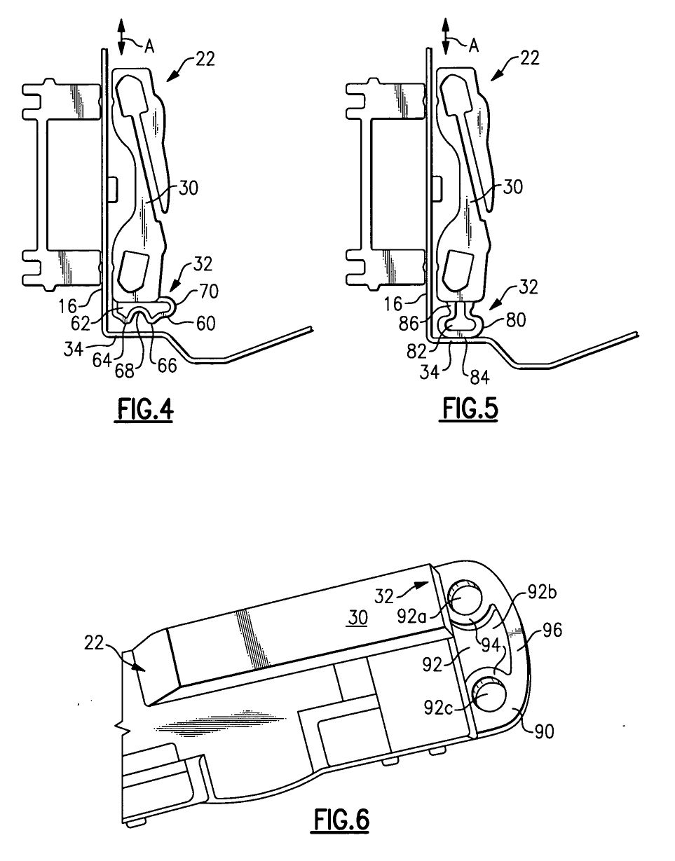

The dampener 32 in FIG. 4 includes a dampener body 60 with a recess formed as an internal cavity 62. The internal cavity 62 is completely enclosed by the dampener body 60. The dampener body 60 includes first 64 and second 66 rib portions that extend outwardly toward the portion 34 of the first rail 16. A recess or groove 68 is formed between the first 64 and second 66 rib portions. A protruding portion 70 extends outwardly from the dampener body 60 in a direction that is transverse to the first 64 and second 66 rib portions. During impact, the first 64 and second 66 rib portions compress or deflect inwardly toward a center of the internal cavity 62 to provide increased dampening.

The dampener 32 in FIG. 5 includes a dampener body 80 with a recess formed as an internal cavity 82. The internal cavity 82 is completely enclosed by the dampener body 80. The dampener body 80 includes a head portion 84 and a neck portion 86 that is smaller in diameter than the head portion 84. The head portion 84 contacts the portion 34 of the first rail 16 when the cursor 22 is in the full down position. During impact, the head portion 84 compresses or deflects inwardly toward the neck portion 86 to provide increased dampening.

The dampener 32 in FIG. 6 includes a dampener body 90 with a recess formed as an internal cavity 92. The internal cavity 92 is completely enclosed by the dampener body 90 and includes three (3) sub-cavities 92a, 92b, and 92c. Curved inner wall portions 94 form the sub-cavities 92a, 92b, and 92c. The dampener body 90 includes a rounded contact portion 96 that engages the portion 34 of the first rail 16. During impact, the rounded contact portion 96 compresses or deflects inwardly toward a center of the internal cavity 92, causing the inner wall portions 94 to compress, which provides increased dampening.

Typically, one of the first 16 and second 18 rails comprises a front rail and the other of the first 16 and second 18 rails comprises a rear rail within the vehicle door module 10. Further, it should be noted that while the examples shown in FIGS. 2-5 show a cursor 22 mounted to the first rail 16, a similar cursor 22 and mounting configuration would be used to mount the cursor 22 to the second rail 18.

The subject invention provides a cursor 22 having an integrally formed body 30 and a compressible dampener 32 that cooperate to reduce adverse effects of impact as the cursor 22 moves to full down position without requiring a separate bumpers to be mounted to rails. Further, the dampener 32 is more durable than traditional bumpers mounted to the rails.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A cursor for a window regulator comprising:
a body including structure for supporting a window panel, said body being movable between a full up position and a full down position; and
a dampener attached to said body to dampen impact when said body moves to the full down position wherein said dampener compresses from an initial position to at least a partially compressed position during impact.

2. The cursor according to claim 1 wherein said dampener and said body are integrally formed as a single piece component.

3. The cursor according to claim 1 wherein said cursor moves along a generally linear path between the full up and full down positions and wherein said dampener is compressible along a path generally parallel to the linear path.

4. The cursor according to claim 1 wherein said dampener includes at least one recess.

5. The cursor according to claim 4 wherein said at least one recess comprises an internal cavity completely enclosed within said dampener.

6. The cursor according to claim 4 wherein said at least one recess comprises a slot.

7. The cursor according to claim 4 wherein said recess is at least partially surrounded by a wall portion and wherein said dampener dampens impact against a window rail when said body moves to the full down position by collapsing said wall portion inwardly toward a center of said at least one recess during impact.

8. A window regulator assembly comprising;
at least one lift rail;
at least one cursor guided by said at least one lift rail between full up and full down positions; and
a dampener mounted for movement with said at least one cursor, said dampener being compressible from an initial position to at least a partially compressed position during impact to dampen impact against said at least one lift rail as said cursor moves to the full down position.

9. The window regulator assembly according to claim 8 wherein said at least one cursor moves along a generally linear path defined by said at least one lift rail and wherein said dampener is compressible along a path generally parallel to the linear path.

10. The window regulator assembly according to claim 8 wherein said dampener and said at least one cursor are integrally formed together as a single piece.

11. The window regulator assembly according to claim 8 wherein said at least one cursor includes structure for supporting a window panel.

12. The window regulator assembly according to claim 11 including a window regulator drive operably coupled to said at least one cursor to move the window panel within a vehicle door module between open and closed positions.

13. The window regulator assembly according to claim 8 wherein said dampener includes at least one recess that is at least partially surrounded by a wall portion and wherein said dampener dampens impact against said at least one lift rail when said at least one cursor moves to the full down position by collapsing said wall portion inwardly toward a center of said at least one recess during impact.

14. A method for dampening impact as a window regulator assembly moves a window panel to a full down position comprising the steps of:
(a) forming a cursor body with structure to support a window panel;
(b) integrally forming a dampener on the cursor body; and
(c) dampening impact with the dampener as the cursor body moves to a full down position by compressing the dampener during impact against a rail.

15. The method according to claim 14 wherein step (c) includes compressing the dampener along an axial path that is generally parallel to a direction of movement of the cursor body.

16. The method according to claim 14 wherein the dampener includes at least one recess at least partially surrounded by a wall portion and wherein step (c) includes collapsing the wall portion inwardly toward a center of the at least one recess during impact.
